(19) United States
(12) Patent Application Publication
(10) Pub. No.: US 2006/0170729 A1
(43) Pub. Date: Aug. 3, 2006

(54) Printer and print head assembly for shuttle motion and in-line printing

(75) Inventors: Richard A. Sloan JR., Southbury, CT (US); Paul R. Sette, Branford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/050,359

(22) Filed: Feb. 3, 2005

(51) Int. Cl. B41J 23/00

(52) U.S. Cl. 347/37

(57) ABSTRACT

An inkjet printer and reconfigurable print head assembly is provided for shuttle and in-line printing upon a media. The reconfigurable print head assembly comprises a print head for depositing ink on the media, a carriage assembly operable to position the print head relative to the media about two axes, and a print head mounting block rotationally mounting the print head to the carriage assembly. Rotation of the print head to a first position enables shuttle motion printing and rotation of the print head to a second position enables in-line motion printing.

### FIELD OF THE INVENTION

The invention disclosed herein relates generally to assemblies for inkjet printing, and more particularly, to a printer and reconfigurable print head assembly adapted for shuttle motion and in-line printing.

### BACKGROUND OF THE INVENTION

Conventional inkjet printers employ a print head assembly having an array of individual nozzles for deposition of ink onto a substrate media or material e.g., plain white paper. The print head assembly is adapted to accommodate one of two types of print/feed mechanisms, namely, shuttle and in-line printing. Shuttle motion printers employ a moveable print head assembly capable of shuttling back and forth in a direction orthogonal to the direction of paper feed. Consequently, shuttle print head assemblies are capable of fully covering the printable area of a page in bands of coverage. In-line printing, in contrast, employs a stationary print head assembly having a fixed width. Generally, in-line print head assemblies comprise a plurality of adjacent print heads to cover a predetermined print area or region as paper is fed beneath the print heads.

A shuttle print head assembly typically comprises a carriage assembly for containing one or more individual print heads. Each print head defines a predetermined coverage height and width in a single row. Additional print heads in a particular row may provide additional colors such as in a CMYK system having a separate head for each primary color. Alternatively, a single print head may be configured for depositing multiple colors. To obtain higher resolution or introduce a greater variety of colors, the print head assembly may require multiple passes across each band.

The carriage assembly is typically connected to a guide rail to fix the print head in two axes and a positioning mechanism to control movement in an axis perpendicular to the media path. The positioning mechanisms typically comprise an electric motor connected to a belt assembly. As mentioned in a preceding paragraph, a shuttle head inkjet printer is capable of covering the entire face surface of the media by incrementally moving media through the print station as the print head passes back and forth in bands of coverage.

Shuttle print head assemblies provide flexibility in coverage and, due to the movement of the carriage assembly, facilitate print head “maintenance” by using a portion of the shuttle movement for maintenance tasks. That is, inasmuch as the print heads must be sealed or “capped off” to prevent the nozzles from clogging with dry ink, the shuttle movement enables wiping and parking of the print head assembly at a maintenance station. On the other hand, it will be appreciated that such print head assemblies are inherently slow due to the oscillating and intermittent motion of the print head assembly. Such a system may paint across the page in one direction only and return the carriage for another pass without printing as the heads return.

An in-line print head assembly typically comprises a plurality of fixed position print heads which are staggered to span a predetermined width. As such, in-line print head assemblies enable coverage across a desired print zone. The print zone is dedicated to printing within a region as paper runs beneath the print heads.

Such in-line print head assemblies provide relatively high throughput, as compared to shuttle head print assemblies, inasmuch as the feed system operates at a nearly constant speed with no time being lost due to oscillating or shuttling of the print heads. Furthermore, fixed print heads utilize unidirectional printing such that all print head characteristics are in the same direction on each printed page. While such print head assemblies provide high throughput, they typically do not enable full-page coverage or facilitate print head maintenance. With respect to the latter, it will be appreciated that the lack of movement, i.e., to a nearby maintenance station, does not permit automated cleaning and sealing of the print heads. Consequently, an operator must detach or disassemble the print head assembly to perform maintenance while the in-line printer remains idle, i.e., between print jobs.

In view of the advantages and disadvantages of each, an operator must predetermine which type of inkjet printer best satisfies his/her printing requirements. If the print jobs require flexibility in terms of the location and/or color of the images to be printed, then a shuttle head inkjet printer may be the best choice. If, on the other hand, the print jobs to be performed require high throughput, then a dedicated in-line inkjet printer may best meet the operator's requirements. However, if the operator cannot predetermine which print jobs will be required, neither the shuttle nor in-line inkjet printers will best serve the operators needs. Hence, to satisfy the potential requirements, the operator must either purchase one of each type of inkjet printers or choose to accept a lack of speed (i.e., characteristic of shuttle head inkjet printers) or a lack of flexibility (i.e., characteristic of in-line inkjet printers).

A hybrid bundled shuttle print head assembly is disclosed in commonly-owned U.S. Pat. No. 6,588,877 entitled METHOD AND SYSTEM FOR PRINTING SPECIFIC PRINT ZONES USING A BUNDLED PRINT HEAD SHUTTLE ASSEMBLY. Therein, a paper feed system positions a substrate material (e.g., a paper envelope) beneath the carriage assembly such that the print head assembly rapidly translates across the envelope for printing in a single pass. The feed system is then indexed for positioning another envelope under the carriage assembly. Printing upon the next envelope is achieved as the print head assembly returns/translates back to its original position. Consequently, the bundled shuttle print head assembly achieves higher throughput speed while minimizing complexity and maintaining print efficacy. While the hybrid print head assembly is a positive step in the evolution of inkjet printers, throughput is non-optimum inasmuch as the feed system must stop and start with each pass of the print head assembly. It will be appreciated that optimum throughput can only be achieved by a system which maintains a constant feed velocity as substrate material is presented to the print head assembly.

Other inkjet printers of the types described above are discussed and illustrated in commonly-owned U.S. Pat. Nos. 6,293,650, 6,367,910, and 6,318,840.

A need, therefore, exists for an inkjet printer which integrates the advantages of shuttle and in-line print head assemblies while mitigating the disadvantages of each.

### SUMMARY OF THE INVENTION

The present invention provides a printer and a reconfigurable print head assembly for shuttle and in-line printing upon a media. The reconfigurable print head assembly comprises a print head for depositing ink on the media, a carriage assembly operable to position the print head relative to the media about two axes, and a print head mounting block rotationally mounting the print head to the carriage assembly. Rotation of the print head to a first position enables shuttle motion printing and rotation of the print head to a second position enables in-line motion printing.

### DESCRIPTION 0F THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

FIG. 1 is a schematic top view of an inkjet printer having a reconfigurable print head assembly in accordance with the teachings of the present invention.

FIG. 2A is an isolated perspective view of the reconfigurable print head assembly according to one embodiment of the present invention.

FIG. 2B is a top view of the reconfigurable print head assembly shown in FIG. 2A.

FIG. 3 is a top view of an alternate embodiment of the reconfigurable print head assembly.

FIG. 4A is a schematic top view of the inkjet printer of FIG. 1 and reconfigurable print head assembly illustrating its use in a shuttle print mode.

FIG. 4B is a schematic top view of the inkjet printer of FIG. 2 and reconfigurable print head assembly illustrating its use in an in-line print mode.

FIG. 5 is a flowchart of a method for printing in accordance with the teachings of the present invention.

### DETAILED DESCRIPTION OF THE PRESENT INVENTION

The present invention describes an embodiment of an inkjet printer and reconfigurable print head assembly therefor. While the embodiments described herein are principally directed to inkjet printers for envelope address printing, it should be appreciated that the invention is applicable to any printer having a substantially in-line or linear array of nozzles, whether bubble-jet, dot-matrix printers, etc. Furthermore, the invention is applicable to printers suitable for printing on any media or material.

The reconfigurable print head assembly of the present invention may be used in combination with any conventional material feed mechanism/transport system. Accordingly, such feed/transport systems will be described only in sufficient detail to understand the structural and functional interaction thereof with the reconfigurable print head assembly of the present invention. Furthermore, the print head assembly may be controlled and positioned by any of a variety of processors and conventional printing/computer interface control systems. Inasmuch as such systems and control algorithms are well-known in the art, such elements also will not be described in detail herein. Moreover, similar to other known inkjet printers and print head assemblies, the inkjet printer and print head assembly therefor employs multiple print heads for delivering and depositing ink on the subject media. This, too, will not be discussed in greater detail. Suffice it to say that a variety of print heads may be employed including thermal inkjet heads such as one-half inch (½″) and one-sixth inch (⅙″) print area heads available from Hewlett-Packard Company under the model designations HP51645A and HP51626A, respectively. Inkjet print heads using other technologies may also be incorporated.

In the broadest sense of the invention, the inkjet printer employs a print head assembly comprising (i) a print head for depositing ink on a media, (ii) a carriage assembly adapted to position the print head relative to the media about two axes, and (iii) a mounting block rotationally mounting the print head to the carriage assembly such that rotation to a first position facilitates shuttle motion printing and rotation to a second position facilitates in-line motion printing.

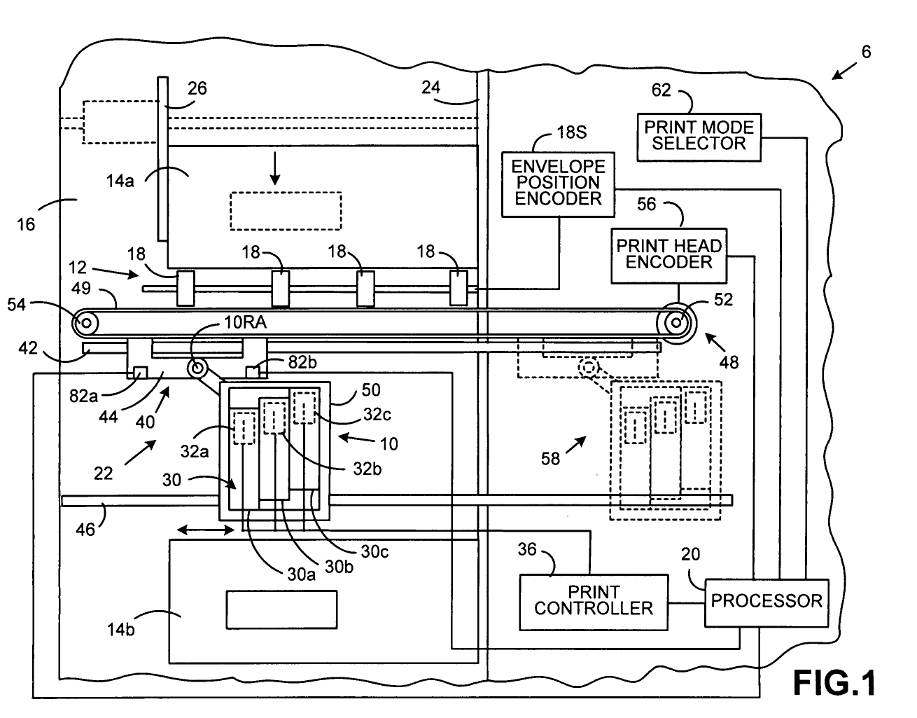

More specifically, and referring to FIG. 1, the reconfigurable print head assembly 10 is shown in combination with the relevant portions of an inkjet printer 6. A feed mechanism 12 is adapted to convey standard envelopes 14a, 14b in a face up orientation, i.e., with the top or major edge fed first into the feed path. In the configuration shown, the inkjet printer 6 and reconfigurable print head assembly 10 are configured/laid for printing in a shuttle print mode.

A media supply feeder (not shown) such as a stack feeder lays envelopes 14a, 14b onto a transport deck 16 of the feed mechanism 12. In the described embodiment, the feed mechanism 12 includes rollers 18 which are driven by a belt (not shown) to impart motion to the envelopes 14a, 14b along the transport deck 16. The feed mechanism 12 includes an envelope position encoder 18S to determine the precise envelope location such that appropriate signals may be issued to a processor 20 to initiate and terminate a print sequence. Furthermore, immediately prior to the introduction of the envelopes 14a, 14b to a print station 22, i.e., the station incorporating the inventive print head assembly 10, the envelopes 14a, 14b are guided by and between a registration wall 24 and a moveable envelope guide 26. In the context used herein, a registration wall 24 is any surface which provides a known lateral location for the processor 20 for controlling the lateral position of the print head assembly. In the embodiment described, the registration wall 24 is integral with housing of the inkjet printer 6 and is substantially perpendicular to the transport deck 16. The feed mechanism 12 is capable of presenting the envelopes 14a, 14b to the print head assembly 10 in rapid succession and, when configured for in-line printing, feeds the envelopes 14a, 14b at a high constant feed rate.

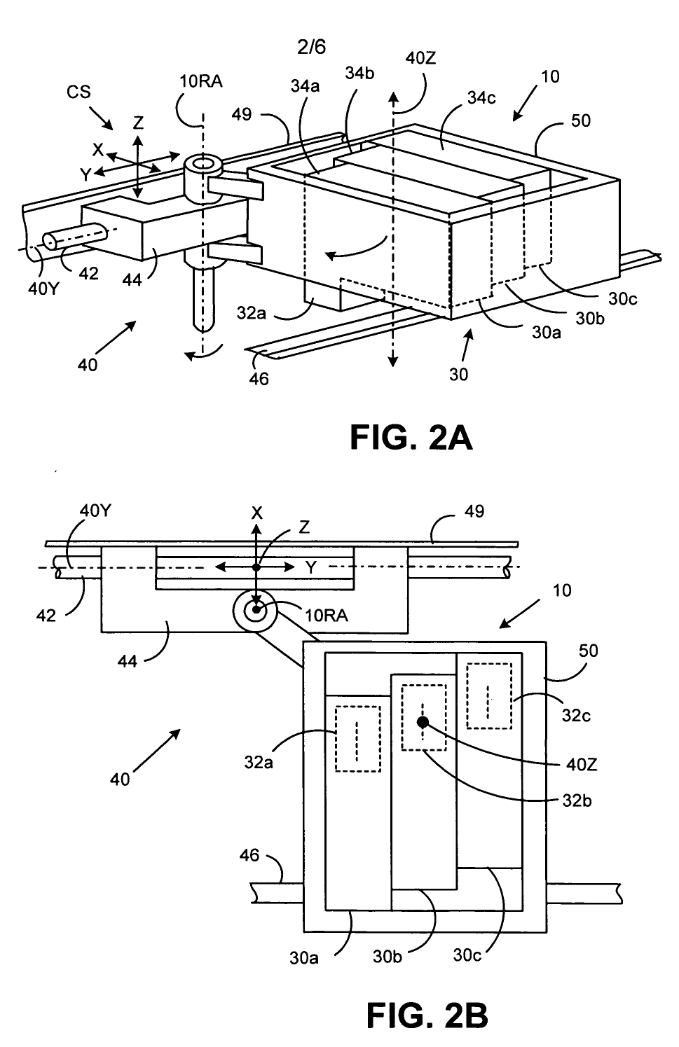

In FIGS. 1, 2A and 2B, the reconfigurable print head assembly 10 includes at least one print head 30 and, in the described embodiment, multiple print heads 30a, 30b, and 30c disposed in a staggered or stepped arrangement to span a predefined width. As mentioned earlier, the print heads 30a-30c are conventional and include an array of nozzles 32a-32c (denoted by a region outlined in dashed lines in FIG. 2B) to deposit ink on the envelopes 14a, 14b. The nozzles 32a-32c are in fluid communication with a reservoir of ink and, in the described embodiment, the print heads 30a-30c include integral ink reservoirs disposed internally of the respective print head cartridges 34a-34c (see FIG. 2A). A flexible wiring harness (not shown) connects to each of the print heads 30a-30c to power and control an internal printed circuit board (not shown) which selectively delivers the ink to the array of nozzles 32a-32c.

Additionally, the reconfigurable print head assembly 10 includes a carriage assembly 40 and a mounting block 50 which is rotationally mounted to the carriage assembly 40. In the broadest sense, the carriage assembly 40 is any mechanism, device, or movable linkage (e.g., a robotic arm) capable of supporting and/or positioning the print heads 30a-30c in two axes. For the purposes of defining direction and position, a Cartesian coordinate system CS is shown (see FIG. 2A) wherein the X axis is disposed in the feed direction of the envelopes 14a, 14b (i.e., along the transport deck 16), the Y axis is orthogonal to the X-axis and in a plane defined by the envelopes 14a, 14b, and the Z axis is normal to the plane of the envelopes 14a, 14b.

The carriage assembly 40 facilitates lateral motion of the print heads 30a-30c horizontally, along a first axis 40Y (see FIGS. 2A and 2B), in a direction orthogonal to the feed direction X and supports the print heads 30a-30c vertically along a second axis 40Z. In the described embodiment, the carriage assembly 40 includes a first guide rail 42 spanning at least the width of the envelopes 14a, 14b, a yoke assembly 44 slideably mounting to the first guide rail 42, and a second guide rail 46 spaced apart from and substantially parallel to the first guide rail 42. The first rail 42 guides the print heads 30a-30c laterally along the first axis 40Y while the first and second guide rails 42, 46, in combination, position the print heads 30a-30c along the second axis 40Z. That is, the first and second guide rails 42, 46 support the print heads 30a-30c along forward and aft portions of the mounting block 50 to position the print heads 30a-30c along the vertical axis 40Z.

While any of a variety of mechanisms may be employed to drive/position the carriage assembly 40 and print heads 30a-30c, the illustrated embodiment of FIG. 1 includes a belt drive mechanism 48 attached to an end of the yoke 44 and proximal to the first guide rail 42. More specifically, the belt drive mechanism 48 includes a flexible belt 49 disposed parallel to the guide rails 42, 46. The belt 49 wraps around a pair of shafts/pulleys 52, 54 which are spaced-apart to accommodate the desired lateral motion of the inventive print head assembly 10. One of the shafts/pulleys 52 is driven in either direction to produce linear motion of the belt 49, and, consequently, linear motion of the print head assembly 10. Moreover, the position of the belt 49 is sensed by a position encoder 56 and feedback to the processor 20.

The processor 20 is operative to receive sensed signals from the position encoder 56 for controlling the print head assembly 10 in accordance with a selected print mode, i.e., a shuttle or in-line print mode. Further, the processor 20 issues signals to a print controller 36 to print the desired characters or images on the envelopes 14a, 14b. As mentioned previously, the control algorithms to translate the print head assembly and to control the deposition of ink are well-known in the art and will not be described in greater detail herein.

In the described embodiment, the carriage assembly 40 may be configured to include a maintenance station 58. That is, while the guide rails 42, 46 are at least of sufficient length to carry the print head assembly 10 across the full face of the envelope 14a, the guide rails 42, 46 may be elongated to enable greater travel of the print head assembly 10, i.e., into the maintenance station 58. There, the nozzles 32a-32c may be wiped of excess ink and capped to prevent the ink in the reservoirs from drying.

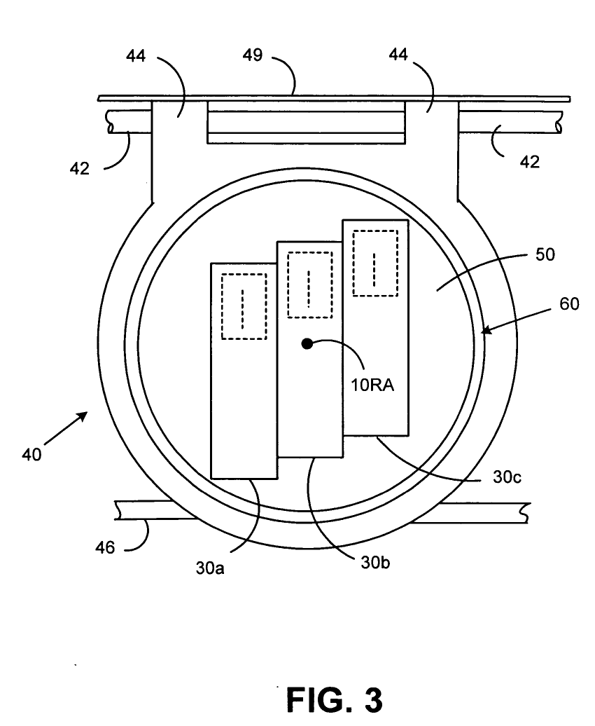

In FIGS. 2A and 2B, the print head mounting block 50 houses the print heads 30a-30c in a staggered array and couples the print heads 30a-30c to the carriage assembly 40. More specifically, the print head mounting block 50 is rotationally mounted to the carriage assembly 40 about an axis 10RA normal to the plane of the envelopes 14a, 14b. In the illustrated embodiment, the print head mounting block 50 is hinge mounted to the carriage assembly 40 such that the rotational axis 10RA is off-set from the print heads 30a-30c. Alternatively, as shown in FIG. 3, the print head mounting block 50 and carriage assembly 40 may be adapted to define a journal mount 60 wherein the rotational axis 10RA passes through the print heads 30a-30c. Irrespective the mounting arrangement, the print head mounting block 50 may be rotated to reconfigure the orientation of the print heads 30a-30c relative to the direction X of envelope feed.

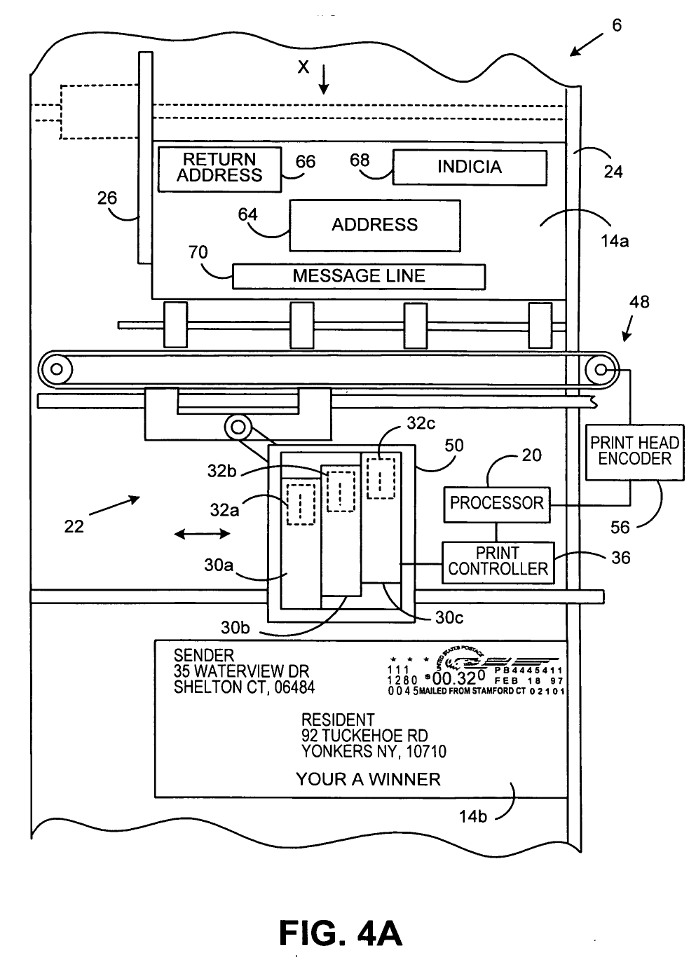

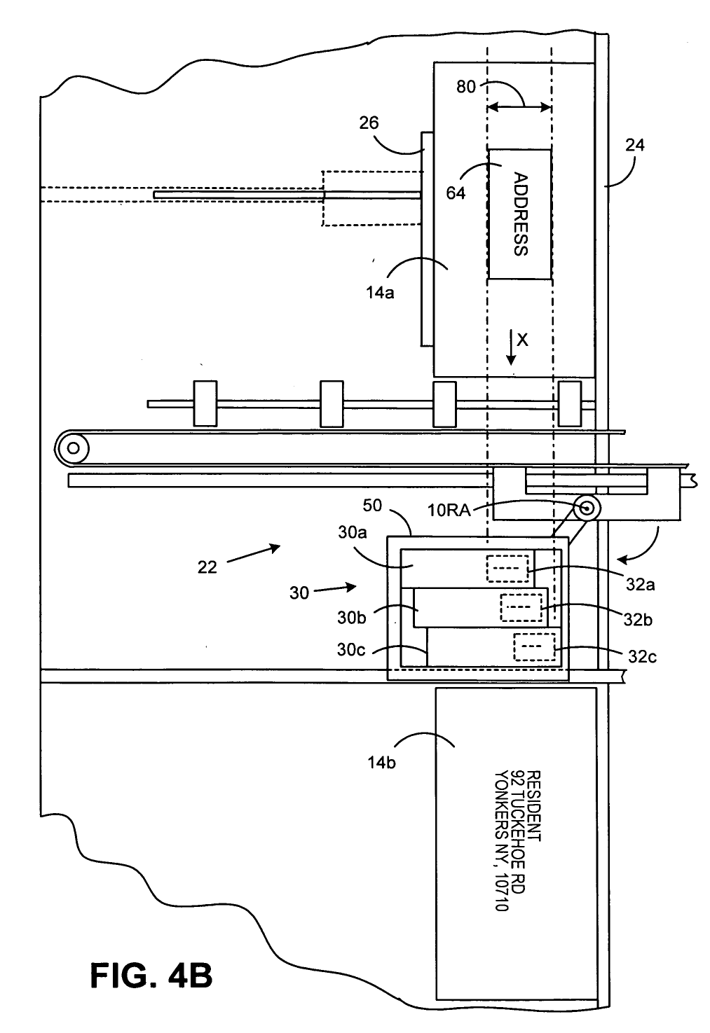

In operation, an operator selects one of two desired print modes, i.e., shuttle or in-line print modes, through a suitable electronic interface e.g., print mode selector 62, (see FIG. 1). In FIG. 4a, the print head mounting block 50 and print heads 30a-30c are positioned for shuttle motion printing, i.e., the nozzles 32a-32c are disposed substantially parallel to the feed direction X of the envelopes 14a, 14b. Further, the envelope guide 26 is appropriately positioned to guide the envelopes 14a, 14b such that the top or major edge is fed first to the print station 22. In this orientation, the print station 22 is controlled by the processor 20 for shuttle motion printing. That is, the print head assembly 10 may be controlled to print anywhere along the face surface of the envelopes 14a, 14b as the reconfigurable print head assembly 10 is caused to shuttle back and forth perpendicular to the feed direction X. In the described embodiment, a destination address 64, return address 66, postage indicia 68 and a message line 70 are fields to be printed, as indicated on envelope 14(a) and as seen on the printed envelope 14b.

In FIG. 4B, the print head mounting block 50 and print heads 30a-30c have been rotated ninety (90) degrees about axis 10RA and are positioned for in-line motion printing. That is, the nozzles 32a-32c are disposed substantially perpendicular or orthogonal to the feed direction X of the envelopes 14a, 14b. Further, the envelope guide rail is appropriately positioned to guide the envelopes 14a, 14b such that the side or minor edge is fed first to the print station 22. In this orientation, the print station 22 is controlled by the processor 20 for in-line motion printing. That is, the print head assembly 10 is positioned such that printing is dedicated to a print zone 80 along the face surface of the envelopes 14a, 14b. In the described embodiment, the print zone 80 corresponds to the destination address 64, though the print heads 30a-30c may be aligned with any desired field, e.g., return address, message line etc. A position or mode sensor (not shown) may be provided to feedback a position signal to the processor 20 that the print heads 30a-30c are properly positioned (i.e., rotated for shuttle or in-line printing).

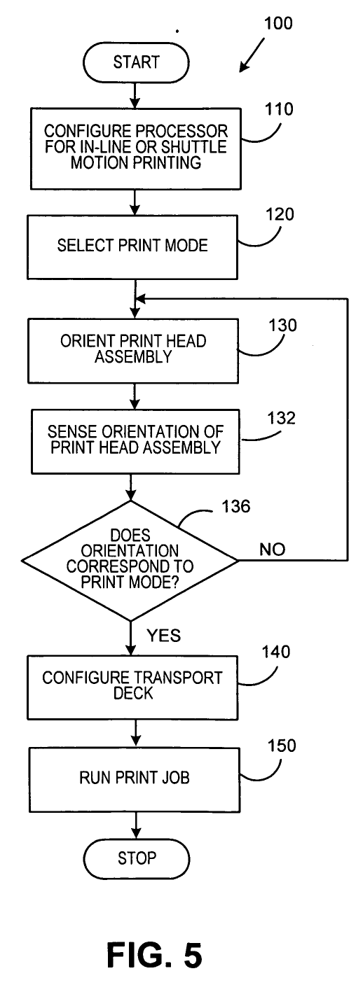

In FIG. 5, a simple flowchart 100 describes the method of printing according to the teachings of the present invention. At step 110, the inkjet printer, i.e., the processor 20, is configured for operation in either a shuttle or in-line motion printing. In this step 110, an inkjet printer 6 is provided with a print head assembly 10 as previously described, and its processor 20 is programmed for both shuttle and in-line printing. Based upon various characteristics of the print job, such as the number and location of the character and/or images to be printed, at step 120 either the operator or the processor 20 selects the optimum print mode for a particular print job. In this step, an operator can make a selection via an electronic interface, i.e., the print mode selector 62, or the processor 20 can select the optimum print mode based upon an analysis of the print job parameters. At step 130, the print head assembly 10 of the inkjet printer 6 is caused to assume an orientation suitable for use in the selected print mode. The print head assembly 10 may be manually or automatically rotated to a position corresponding to the selected print mode. Any means for rotating and locking the print head assembly 10 in place will function for this purpose. With respect to automated rotation of the print head assembly 10, an electric motor or other gear mechanism (not shown) may power its rotation ninety (90 ) degrees clockwise or counterclockwise depending upon the print mode selected. At step 140, other adjustments to the inkjet printer 6, such as positioning the envelope guide rail 26 on the transport deck 16, may be required depending upon the dimensions of the media. If the transport deck 16 includes center justified mechanically interlocked envelope guides, it may be necessary to include position encoder feedback to ensure that the print heads 30a-30c are correctly positioned. At step 150, the print job is run in either a shuttle or in-line print mode.

In summary, the inkjet printer 6 and reconfigurable print head assembly 10 of the present invention accommodates printing in either a shuttle or in-line printing mode. As such, an operator is no longer required to predetermine his/her print requirements or acquire an inkjet printer to meet each requirement. The operator can also obtain optimum throughput when in-line printing and optimum quality when shuttle printing. The invention also provides the capability to shuttle the print heads to an adjacent print zone while in-line printing. That is, postage indicia (in one print zone) could be printed and, by shuttling the head to a new zone, the destination address can be printed (in an adjacent zone), all while printing in an in-line print mode. Furthermore, the same drive mechanism employed to shuttle the print heads back and forth may be used for positioning the print heads when printing in an in-line print mode. Additionally, The print head assembly 10 need only be rotated ninety (90 ) degrees to accommodate each of the desired print modes; Moreover, the configuration of the print station accommodates docking of the print head assembly 10 at a maintenance station while the inkjet printer is idle or between print jobs.

While the present invention has been disclosed and described with reference to a single embodiment thereof, it will be apparent as noted above that variations and modifications may be made therein. It is also noted that the present invention is independent of the machine being controlled, and is not limited to the control of inserting machines. It is, thus, intended in the following claims to cover each variation and modification that falls within the true spirit and scope of the present invention.

What is claimed is:

1. A print head assembly for printing on a printer with a media transport deck, the print head assembly comprising:
at least one print head;
a carriage assembly operable to position the print head relative to the deck about two axes; and
a mounting block rotationally mounting the print head to the carriage assembly wherein rotation of the print head to a first position enables shuttle motion printing and rotation of the print head to a second position enables in-line motion printing.

2. The print head assembly according to claim 1 further comprising a plurality of print heads juxtaposed in a staggered array.

3. The print head assembly according to claim 1 wherein the media is fed to the print head assembly in a feed direction and wherein the carriage assembly is operative to shuttle the print head assembly along a first axis orthogonal to the feed direction and position the print head assembly about a second axis perpendicular to the first axis.

4. The print head assembly according to claim 1 wherein the mounting block rotates about an axis normal to a plane defined by the deck.

5. The print head assembly according to claim 4 wherein the rotational axis is off-set from the print head.

6. The print head assembly according to claim 4 wherein the rotational axis passes through the print head.

7. The print head assembly according to claim 1 wherein the carriage assembly in combination with the mounting block define a hinge mount.

8. The print head assembly according to claim 1 wherein the carriage assembly in combination with the mounting block define a journal mount.

9. The print head assembly according to claim 3 wherein the carriage assembly comprises:
a first guide rail extending along the first axis;
a yoke assembly slideably connected to the first guide rail at one end thereof and supporting the mounting block at the other end; and
a second guide rail spaced apart from and substantially parallel to the first guide rail, the guide rails in combination positioning the print heads along the second axis.

10. An inkjet printer comprising:
a housing having a registration wall;
a print station supported by the housing and having a rotatable print head assembly;
a transport deck adjacent to and substantially perpendicular to the registration wall, the transport deck extending from an input end to an output end whenever the print station is located therebetween;
a selection interface for selecting one of at least two print modes, the print modes including an in-line print mode and a shuttle motion print mode; and
a signal processor operative to receive sensed signals from the selection interface to configure and control the print station in accordance with the selected print mode,
whereby the print head assembly may be rotated to a position corresponding to the selected print mode.

11. The printer according to claim 10 further comprising a moveable guide rail disposed in combination with the transport deck and disposed substantially parallel to the registration wall, the guide rail being disposed upstream from the print station.

12. The printer according to claim 10 wherein the print head assembly includes:
a print head operative to deposit ink;
a mechanism operative to position the print head along a first axis; and
a means for rotating the print head about a second axis normal to a plane defined by the transport desk.

13. The printer according to claim 12 wherein the means for rotation of the print head includes a mounting block supporting the print head wherein the mounting block is hinge mounted to the positioning mechanism.

14. The printer according to claim 12 wherein the means for rotation of the print head includes a mounting block supporting the print head wherein the mounting block is journally mounted to the positioning mechanism.

15. The printer according to claim 13 wherein the positioning mechanism is a carriage assembly operative to shuttle the print head assembly about a first axis orthogonal to a feed direction of the media and position the print heads assembly about a second axis perpendicular to the first axis.

16. The printer according to claim 15 wherein the carriage assembly comprises:
a first guide rail spanning the width of the media and defining the first axis;
a yoke assembly slideably connected to the guide rail at one end thereof and supporting the mounting block at the other end; and
a second guide rail spaced apart from and substantially parallel to the first guide rail, the guide rails in combination positioning the print heads along the second axis.

17. A method for in-line and shuttle motion inkjet printing, comprising the steps of:
configuring the processor of an inkjet printer for operation in one of at least two print modes, the print modes including an in-line and shuttle print mode, the configuration step including the sub steps of:
selecting the optimum print mode for a particular print job;
causing the print head assembly of the inkjet printer to assume an orientation suitable for use in the selected print mode; and
running the print job in accordance with the selected print mode.

18. The method according to claim 17 wherein the print head assembly includes:
a print head operative to deposit ink on the media;
a mechanism operative to position the print head relative to the media; and a means for rotating the print head about an axis normal to a plane defined by the media.

19. The method according to claim 17 wherein the step of orienting the print head assembly includes rotating the print head assembly about an axis normal to a plane defined by the media.

20. The method according to claim 19 wherein the print head assembly is rotated at a substantially right angle to reconfigure the print head assembly from one print mode to another.

21. The method according to claim 20 further comprising the steps of:
sensing the position of the print head assembly;
comparing the sensed position to the selected print mode; and
running the print job when the sensed position and selected print mode agree.
